(19) United States
(12) Patent Application Publication
(10) Pub. No.: US 2023/0191744 A1
(43) Pub. Date: Jun. 22, 2023

(54) META-MATERIAL EMBEDDED KNITTED-FABRIC OR BLANKET FOR SPACE APPLICATIONS

(71) Applicant: United Arab Emirates University, Al Ain (AE)

(72) Inventors: Zishan AKHTER, Al Ain (AE); Pranay RANJAN, Al Ain (AE)

(21) Appl. No.: 17/559,145

(22) Filed: Dec. 22, 2021

(51) Int. Cl. B32B 5/26; B32B 27/28; B32B 5/02; B32B 27/08; B32B 38/08

(52) U.S. Cl. CPC B32B 5/26; B32B 5/026; B32B 27/08; B32B 27/281; B32B 38/08; B32B 2255/10; B32B 2255/205; B32B 2262/0284; B32B 2264/10; B32B 2307/304

(57) ABSTRACT

There is disclosed a multi-layer insulation material, comprising a sheet or a blanket including a plurality of alternating layers of insulating materials, coated with foil, wherein the multi-layer insulation material is embedded with meta-materials and wherein outer layers of the multi-insulation material comprise of polyimide. A method of manufacturing a meta-material embedded fabric is also disclosed, the method including embedding borophene and hybrids of borophene with a two dimensional (2D) material; integrating borophene or plumbene hybrid flakes under an inert ambience with the 2D material; synthesizing the embedded borophene and hybrids of borophene using a sono-chemical technique; and reducing the synthesized borophene and hybrids of borophene using a blended reaction protocol, thereby forming the meta-material embedded fabric.

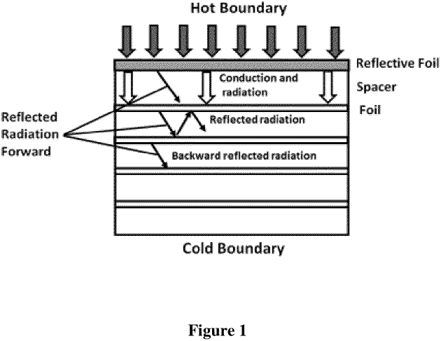

### FIELD OF THE INVENTION

The present invention relates to the field of multilayer insulation (MLI), and more particularly to a meta-material embedded MLI for defense and aerospace applications.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Lightweight, porous, high-performance electromagnetic interference (EMI) shielding and fire-resistant fabrics are in high demand and highly sought for defense and aerospace applications. The design, modeling and fabrication of an efficient Multi-Layer Insulation (MLI) requires proper planning and enabling all the three kind of heat transfer modes. In general cases, only two heat transfer modes (conduction and convection) are considered due to room temperature end applications. However, for a defense and spacecraft application, Multi-Layer Insulation (MLI) uses one or more type of radiation and heat-transfer barriers to debar the rate of energy flow. The radiation barriers used are typically made up of thin polymer films having thin metal film deposited either one side or both sides by physical vapor or chemical vapor techniques. As it is near to impossible to reflect 100% of any incident radiation on any designed blanket, a MLI is fabricated with a series or multiple blankets (also called as sub blankets) arranged systematically over each other to fit over asymmetric geometries.

Typically, in case of a multilayer MLI, each reflector use to reflect nearly 90% of the incoming radiation and the cumulative effect is 100% barrier to incident radiation. Recently, it has been noted that the polyimide layer and metal layer coating on the polymer film are not useful for military or spacecraft applications at elevated temperatures or under robust conditions. Moreover, exposure to severe radiations owing to electromagnetic waves, plasma, high-energy electrons and ions, cosmic rays, etc. poses concerns of electronics damage and operations failure. Furthermore, these elastomers struggle with thermal management and provide poor protection against atomic-oxygen corrosion, space charging and radiation shielding - there unsuitable for use.

Peterson et al. in 1958 developed the first MLI and the process of design, style, configuration and manufacturing was later on improved significantly over the past few decades. In the era of 1960-1980 more than 120 research papers were reported to the Advances to Cryogenic Engineering. MLI was a very crucial necessity for the military and aerospace sector. In the early 1960s and late 1970s, a large number of researchers and scientists have actively participated to manufacture MLI (the program was named as Apollo). MLI is considered to work best under a pressure of below 10-3 torr. Mylar and Kapton tapes coated with thin metal layers are the two widely used thermal radiation shields used in military and spacecraft. However, these metal layers melt or degrade above 300° F., and therefore these metal coated MLIs are suitable only for room temperature applications (they are also cheap, light and have lower thermal conductivity in comparison to the metal foils). As another aspect, cost is another factor considering end-use applications and therefore based on emissivity - pricey metals like aluminium, silver or gold are coated through chemical vapor or physical vapor deposition techniques.

During deposition of the metals on Mylar or Kapton tape it should be noted that the thickness of the depositions should not be more than 500 Å, because above this thickness, the polymer in Kapton or Mylar tape loses its flexibility. Moreover, it has been discovered that as the temperature increases, the thickness should decrease. In a recent experiment by Fermi National Lab it was found that thickness is a very important parameter if the application is related to elevated temperature. Further, it is also worth mentioning that MLI is fragile and easily damaged even under controlled conditions. All the above mentioned limitations of conventional MLI limits its overall role and applications.

Multi-layer insulation (MLI) sheets used for blanketing satellites are essentially composed of several foils of Kapton and Mylar placed over each other, separated by low-thermal conductive spacers. The thickness of sheets varies within millimeters and provide thermal insulation against radiation, solid and gas conduction. The MLI sheets were introduced in the 1950s, and have been extensively used for various applications such as cryogenic tank insulation, MRI scanning and thermal management of satellites and spacecrafts. The MLI sheets installed on the satellites or spacecrafts provide passive thermal insulation by reflecting radiative heat falling on the surface. These successive reflections at each layer provide thermal insulation to the internal components of the satellite or spacecraft. Several experimental investigations have been carried out to obtain the optimum material composition and effectiveness of the MLI sheets. Bapat et al. tried different sequences of spacer and shield materials for the effective performance of MLI sheets. The experimental and numerical results exhibited a promising combination of aluminized Mylar (12 µm) and glass fabric (76.2 µm). The effect of shape on the MLI performance was reported by Wei et al., who demonstrated degradation in heat flux response by deformed perforated MLI installed on a calorimeter with spherical top and bottom surface. The deterioration was owed to the edge-effect produced by wrapping the MLI on the spherical surface. Sun et al. investigated the behavior of MLI sheets under various conditions prevalent in space. The experimental investigation employed air, and gases such as Ar, N2 and CO2 to quantify the effect of interstitial gas-pressure. They conducted extensive testing over a gas-pressure range of 10-3 Pa to 10-5 Pa, over-temperature variation of 77 K to 300 K, and it was concluded that the thermal conductivity of the MLI sheets increases with temperature and vacuum magnitude. The optimal layer density for MLI sheets has also been explored, and the experimental results recommended a lower density of layers to enhance the mass and heat loading of the sheets. The effectiveness of MLI sheets subject to temperature variation has been studied by Thomas et al., wherein they passed cryogenic liquid Helium through a pipe wrapped with MLI specimen. The performance of MLI sheets was challenged by the leakage of H2 gas (medium), and the presence of N2 and O2 traces between the sheets. The use of Getters was recommended by the researchers to absorb contaminating gases. A composite getter comprised of copper oxide and carbon was introduced by Jian et al., and it was proved effective and economical for hydrogen gas absorption. Application of aerogels for thermal insulation has been proposed by Fesmire, wherein the aerogel composite was developed for non-vacuum applications such as spacecraft’s, propulsion test-stand/Launchpad, cryogenic tanks, etc. The transmissivity of MLI sheets has been investigated at an ultra-low temperature of 2 K by Johnson et al, where the researchers used an adaptive laser system for measurement and reported zero-transmissivity at such temperature. Several tests were conducted by researchers using different MLI specimens, and it was concluded that various MLI combinations are effective in thermal insulation and their suitability is dictated by the end-application. Further, several numerical investigations have also been conducted by researchers to model the effectiveness of MLI sheets based on varying compositions and environmental conditions. Bapat et al. modelled the MLI sheet composed of double-aluminized Mylar reflective foil, separated by glass-fabric spacers. The researchers investigated radiation, and conduction (solid and gas). They reported enhancement in gas conduction with the increment in layer density. A computer program was developed by McIntosh to optimize the heat-flux performance of MLI sheets.

Helium gas pressure of 1.33*10-5 Pa was applied and achieved improvement in the heat-flux response with the introduction of denser layers near the warm boundaries. Further thermal, and radiative response concerning emissivity and conductance of MLI sheets was computed by researchers, who employed the inverse problem method to measure the temperature and heat fluxes. The thermal resistance of MLI sheets has also been investigated by researchers. They studied the effect of air gaps around the sheet and recommended a gap of 3 cm for maximum resistivity. A thermal protection system was modelled by Gongan et al., who optimized the 3D model for mechanical and thermal loads while minimizing the weight. The researchers achieved a 37% reduction in the system weight. An extensive parametric study of MLI sheets has been performed by Tingwu et al., wherein the numerical investigation explored the effects of layer properties such as density, emissivity, thickness, orientation, sequence, and number. The optimal number of layers was reported to be 18, beyond which the conductivity increased due to the dominance of conductive metal-foils. Designing of spacers has also been considered for performance enhancement. A wrapped MLI with isolated spacers was proposed by Dye et al., wherein various spacer designs featured a reduced area/length ratio to curtail thermal conductivity. A comparative study on the thermal insulation of cryogenic liquid-H2 tank using foam and MLI sheets has been performed by Zhan et al., wherein the quasi-steady-state model predicted the superior performance of MLI sheets over higher temperature regimes marked by radiant heat transfer. The introduction of phase-change material in the middle layers of the MLI sheets has been recommended by researchers to enhance thermal effectiveness. However, the enhancement is reported to fade as the phase-change material is sequenced towards the bottom of the MLI sheet. A design criterion for multilayered wall insulation, aimed at improving the effectiveness was also developed by researchers.

Studies combining modelling and experimental investigations of MLI sheets have also been reported by the researchers. The experimental heat-flux response of MLI sheets was compared with several empirical models- conductance, emittance, conduction-radiation, and Cunnington and Tien (CT-model), wherein the researchers reported the CT-model to be most precise in the prediction of heat-flux. Further, the effectiveness of MLI sheets composed of porous and fibrous layers was also investigated by researchers. These layers featured capability to absorb, emit and scatter incoming radiation, thereby improving performance. Ohmori introduced a dimensionless pressure parameter P*, for the accurate prediction of wrapped MLI sheet performance. Theoretical modelling of MLI behavior under high thermal loads was done by Huang et al., wherein they employed the inverse problem method for analysis and compared it with experimental data. A variation of 4% in thermal conductivity was reported by the researchers. A novel non-interlayer-contact spacer design with reduced area/length ratio of 10-5 was proposed by researchers for the MLI. It was composed of poly-etheretherketone. Another novel MLI design was proposed by Haim et al., where they used coaxial stainless-steel foils with zirconia particles (50 µm diameter) as spacers, dispersed in N2-gas between the layers. The zirconia spacers were observed to be effective in reducing heat transfer between the layers under vacuum conditions. Modelling of MLI sheets for cryogenic tank insulation has also been done. Researchers have used simulations to accurately predict the cryogenic boil-off and thermal conductivity of sheets to assist in optimal tank-designing. Dacron net has also been introduced as spacer material between the foils of MLI sheet.

Accordingly, there exists a need for an MLI design fabric or sheet, which overcomes the drawbacks faced by traditonally employed insulation materials.

### SUMMARY OF THE INVENTION

Therefore it is an object of the present invention to develop an MLI design fabric or sheet, which overcomes drawbacks of traditionally employed distillation techniques and/or systems.

There is disclosed a multi-layer insulation material, comprising a sheet or a blanket comprising a plurality of alternating layers of insulating materials, coated with foil, wherein the multi-layer insulation material is embedded with meta-materials and wherein outer layers of the multi-insulation material comprise of polyimide.

In an embodiment of the present invention, the meta-materials are borophene and hybrids of borophene i.e. freestanding borophene / plumbene hybrids materials.

In another embodiment of the present invention, the foil includes metal foil comprising silver or aluminium.

In another embodiment of the present invention, the coating is on a single side, or both sides of the plurality of alternating layers.

In another embodiment of the present invention, the insulating materials include Kaplan or Mylar polyimide outer surface coated with freestanding borophene / plumbene, boron nitride and graphene hybrid layer coated on to it through spray coating.

In another embodiment of the present invention, the multi-layer material is a knitted wire-mesh fabric.

As another aspect of the present invention, a method of manufacturing a meta-material embedded fabric is proposed, the method comprising. The novel sheet features freestanding borophene/plumbene, boron nitride and graphene hybrid coating on the polyimide outer surface while introducing freestanding borophene/plumbene and boron nitride hybrids as a spacer between the insulating layers. Freestanding borophene/plumbene and boron nitride hybrids flakes are dispersed in nitrogen gas between the successive layers to offer strong thermal resistance against heat conduction., synthesizing the embedded borophene and hybrids of borophene (with plumbene) using a sono-chemical technique; and reducing the synthesized borophene and hybrids of borophene using a blended reaction protocol, thereby forming the meta-material embedded fabric.

In an embodiment of the present invention, the borophene used is freestanding borophene.

In another embodiment of the present invention, the inert ambience comprises dispersing the hybrid flakes in nitrogen gas, to result in strong thermal resistance against heat conduction.

In another embodiment of the present invention, the 2D material is coated on to the Kapton or Mylar foils

In another embodiment of the present invention, synthesizing the embedded borophene and hybrids of borophene/ plumbene is performed using the sono-chemical technique along with an improved and modified Hummer’s technique.

As another aspect of the present invention, a meta-material embedded fabric is proposed, comprising a plurality of insulating layers, a polyimide outer surface with a coating of freestanding borophene, plumbene, boron nitride and a plurality of graphene hybrid layers.

In an embodiment of the present invention, the meta-material embedded fabric acts as a shield against thermal flux, hostile radiations, space junk, galvanic corrosion, atomic oxygen and is fire resistant.

In another embodiment of the present invention, freestanding borophene, plumbene and boron nitride hybrids are introduced as a spacer between the plurality of insulating layers.

In another embodiment of the present invention, freestanding borophene, plumbene and boron nitride hybrids flakes are dispersed in nitrogen gas between the plurality of insulating layers, thereby offering strong thermal resistance against heat conduction.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

The FIGURE. illustrates a schematic representation of a traditional multi-layer insulation (MLI) design.

### DETAILED DESCRIPTION OF THE INVENTION

The aspects of the proposed MLI design, according to the present invention will be described in conjunction with the FIGURE In the Detailed Description, reference is made to the accompanying figures, which form a part hereof, and in which is shown by way of illustration specific embodiments in which the invention may be practiced. It is to be understood that other embodiments may be utilized and logical changes may be made without departing from the scope of the present invention. The following detailed description, therefore, is not to be taken in a limiting sense, and the scope of the present invention is defined by the appended claims.

Multilayer Insulation (MLI) is useful in crucial applications such as defense and aerospace. Satellites are spacecrafts launched into space for crucial tasks such as remote sensing, communication, etc. These satellites are launched into different orbits based on the tasks assigned to them. They revolve in the earth’s orbit and are required to continuously endure the hostile environment in space. Satellites are further subject to constant thermal flux as they progressively move into/out of the sunlight. This triggers continuous expansion/contraction and the materials used are challenged to maintain dimensional stability by retaining their shape and size for proper functioning of on-board equipment. The materials are also subject to hostile radiations in space comprising majorly of the electromagnetic spectrum (EM), solar flares (X-rays, gamma-rays), space radiation (streams of ions, protons, electrons), and galactic cosmic rays, among others. These radiations have serious consequences on the satellites as well as on other space missions. Further, these satellites also experience extreme forces and stress and strain, varying from the launch phase to operations in microgravity. Also, the satellites are threatened by meteorites and/or projectiles originating from space-junk. These meteorites and/or shrapnel travel at very-high velocity and can shred other satellites upon impact, thereby leading to fatal consequences. Accordingly, in order to cope with the various threats and challenges, the crucial parts of satellites or other space vehicles are wrapped in a unique Multi-layer Insulation (MLI) sheet or blanket.

Lightweight, porous, high-performance electromagnetic interference (EMI) shielding and fire-resistant materials or fabrics are highly sought for Defense & Aerospace applications. Atomistic flat materials (especially meta-materials) bestow high tensile strength, super-hydrophobicity, flexibility, enhanced conductivity, and superb EMI-shielding at minimal thickness. The much-needed shielding is mandatory to avoid reconstruction of intelligible data, termed as TEMPEST (Telecommunications Electronics Material Protected from Emanating Spurious Transmissions). In the battlefield, NEMP (Nuclear Electromagnetic Pulse) is applied, which consists of highly concentrated, magnified bursts of EM-radiation produced by nuclear explosions. NEMP leads to frequent changes in electric and magnetic fields by generating a surge in current or voltage. This poses threats to electrical and electronic systems, eventually leading to fatal damages. Moreover, NEMP also generates thermal shocks by increasing local temperature to beyond 250° C. In addition, these defense machines also face galvanic corrosion prompted by salt fog in coastal or marine areas. Therefore, there is the utmost need for a fabric which should provide electromagnetic shielding, fire-resistance, galvanic shielding, and NEMP protection to the costly and strategically crucial defense and aerospace equipment.

It is an objective of the present invention to propose an effective single layer MLI, keeping in mind important factors such as material selection, design, and assembling - in order to reduce overall costs, weight, thermal stability and mechanical strength. The proposed MLI comprises a sheet or a blanket composed of alternating layers of insulating materials such as Kapton and Mylar, coated on single or both sides of metal foils such as silver or aluminium. The outer layers of the proposed MLI is comprised of polyimide, which has a distinct yellowish-golden luster or hue. The proposed MLI sheet is characterized by high thermal insulation, which maintains an optimal temperature of a satellite or space craft, exhibit dimensional stability and are very stable towards thermal variations which occur in space. An important requirement of MLI is thermal management. Satellites or spacecrafts usually experience thermal cycling characterized by extreme temperatures in the orbit. Solar radiations heat the satellites or spacecrafts to several hundred degrees, posing major risks to the on-board equipment. On the contrary, satellites may also experience an extremely cold environment (several hundred degrees below zero), while passing through the eclipse of earth and/or any other celestial bodies. The extreme temperatures and thermal shocks endanger the lifetime and overall operation of the satellite or spacecraft. Accordingly, on-board components of space bodies such as satellites or spacecrafts require maintenance of temperature in a moderate range in order to function optimally. Traditionally, this requires heating/cooling of the components intermittently to maintain the desired temperature. However, this heating/cooling requires energy (electricity) which is available only in limits on-board the satellite or spacecraft. Hence, the proposed MLI sheet or blanket is a feasible and lightweight solution to this traditional problem.

An application of the MLI sheet or blanket is to offer protection against micro-meteorites and space-junk. Satellites revolve at high velocities in orbit, for example ISS has an orbital velocity of 7.6 km/s. The impact of micrometeorites or shrapnel at such speeds may shred the satellite or spacecraft and can be fatal for the mission. The proposed MLI sheets or blankets are not only strong but also made of redundant sheets that offer prolonged protection to the satellite or spacecraft components. Another traditional drawback of an MLI is that associated with space charging (the buildup of charge on/inside of the satellite or spacecraft). Space charging is caused mainly by sputtering of high-velocity electrons and/or ions on the satellite or spacecraft body. This leads to a difference in the electrostatic potential between the satellite or spacecraft body - and the bordering plasma environment. An electric differential is also generated across the various sections of the satellite or spacecraft (termed as differential charging). Furthermore, high-energetic ions/electrons penetrate and accumulate inside the satellite or spacecraft chamber to generate internal charging. Space charging also leads to electrostatic discharges and/or generates electromagnetic fields, which then lead to severe consequences owing to structural damages/degradation of components, operational anomalies of electronics and the loss of navigation and communication. MLI is tasked with providing satisfactory insulation against plasma radiation while exhibiting conducting surface to prevent differential charging across the surface. However, merely a tradeoff is achieved by traditionally employed MLI sheets which provide partial conducting surfaces and often require coatings of conducting paint (such as indium oxide) at vulnerable locations.

Considering yet another challenge for satellites or spacecrafts in orbit is limited protection against Atomic Oxygen (AO), especially in the lower-earth orbit (LEO). The UV radiations interact with oxygen in the upper atmosphere and generate AO. AO are highly reactive and corrosive due to their intrinsic oxidative nature. Metals such as silver, copper, and osmium are observed to be most susceptible to AO-corrosion. Likewise, polymers having carbon, nitrogen and hydrogen bonding are also worst affected. Hence, traditionally - satellites and spacecrafts need to be coated with anti-corrosion coatings and/or mounted with metal shields in order to prevent damages incurred by AO.

Typically, elastomers embedded with silver-plated aluminium, silver-plated copper, pure nickel and nickel-coated graphite are used as multi-layer fabrics for EMI shielding in aerospace, military and/or satellite communications owing to their high thermal stability (-40° C. to +160° C.). However, these elastomers or fabrics fail when subjected to extreme thermal cycling, leading to a substantial lifetime decrement of on-board materials or equipment. Further, exposure to severe radiations (such as those faced by satellites or spacecrafts in space) from electromagnetic waves, plasma, high-energy electrons, ions and cosmic rays pose concerns of electronics damage and operations failure. Furthermore, these elastomers struggle with thermal management and provide poor protection against atomic oxygen corrosion, space charging and radiation shielding. As a solution to these existing problems, a knitted wire-mesh fabric or material (sheet or blanket) is proposed - embedded with meta-materials (borophene and its hybrids), which will cater to the abovementioned challenges.

In the present invention, borophene and its hybrids are used for coating the insulative fabric layers. Borophene possesses unprecedented high mechanical strength, conductivity, mobility, dimensional stability, and irradiance as compared to conventional 2D and 3D materials. The hybrids of freestanding borophene, graphene and boron nitride boost the material properties and offer enhanced fabric performance. Further, inclusion of the freestanding borophene and its hybrids with graphene and boron nitride as the coating significantly boost surface conduction, thermal management and shielding, and the absence of dangling bonds and strong inter-atomic (in-plane) bonding makes them highly inert. This provides excellent protection against fatal corrosion caused by atomic-oxygen and/or sputtering of high-energy particles on the surface, especially in the outer atmosphere. In another embodiment of the present invention, the proposed novel-fabric solves the challenges faced by the defense and aerospace (spacecraft) industry involving electromagnetic shielding, thermal management, fire-resistance, galvanic shielding, NEMP protection, space charging, and atomic-oxygen corrosion. It not only improves the performance of the existing system but also deliver additional features thereby, extending the lifetime of electronic components as well as the shell life of defense, aerospace and satellite gadgets.

The Meta-Material Embedded Knitted-Fabric (sheet or blanket) proposed in the present invention is composed of freestanding borophene (or plumbene) hybrid materials. The Meta-Material Embedded Knitted-Fabric has polyimide outer surface with freestanding borophene, boron nitride and graphene or plumbene hybrid layers coated on to it. This potentially reduces the use of polyimides such as Kapton and Mylar in the Meta-Material Embedded Knitted-Fabric for a desired or pre-determined performance. The proposed sheet features freestanding borophene, boron nitride and graphene hybrid coating on the Kapton and Mylar foils while introducing freestanding borophene and boron nitride hybrids as a spacer between the insulating layers. Freestanding borophene and boron nitride hybrids flakes are dispersed in nitrogen gas between the successive layers to offer strong thermal resistance against heat conduction. These hybrids are characterized as having exceptional strength, dimensional stability, irradiance, and electrical conductivity. Collectively, these features contribute towards the proposed Meta-Material Embedded Knitted-Fabric (sheet or blanket) to be lighter, stronger and economical, while offering superior performance compared to the state-of-the-art or traditional MLIs used.

The proposed sheet or blanket allows for enhanced dimensional stability, thermal management, radiation shielding and protection against rupture by micro-meteorite and/or projectiles, when in operation. Furthermore, the proposed sheet or blanket resolves two critical challenges faced by traditional MLIs, such as space charging, and atomic-oxygen corrosion. The presence of freestanding borophene and graphene hybrids coating significantly boosts surface conduction and shielding, which eliminates or significantly reduces damages caused due to space charging. Also, a high Young’s modulus of the graphene and borophene hybrids offer excellent protection against fatal atomic-oxygen corrosion, prevalent in the low-earth orbit. Eventually, the proposed Meta-Material Embedded Knitted-Fabric significantly improves the performance of traditionally employed MLIs, while offering additional crucial features. Thus, the proposed sheet or blanket enables extending the lifetime of in-orbit critical components and/or the satellite and will therefore be highly rewarding for the defense industry (fighter aircrafts, tanks, satellites, warfare machinery, among others will be highly protected against space and NEMP damages using the present invention) and/or the aerospace sector (satellites employed in fields such as, but not limited to, telecommunication, meteorology and the IT industry).

The present invention deals with a knitted fabric (sheet or blanket) to be used in defense and aerospace applications, comprising a method of embedding freestanding borophene and its hybrids with 2D materials on the knitted fabric, and then integrating of freestanding borophene hybrids flakes under an inert ambience. In another embodiment of the present invention, the proposed fabric (sheet or blanket) comprises the chemical synthesis of freestanding borophene and its hybrids using sono-chemical and a modified or improved Hummer’s Technique, following the reduction of functionalized freestanding borophene and its hybrids sheets using a blended reduction protocol involving thermal as well as a microwave reduction technique. Sono-chemical and chemical synthesis routes are used for industrial/mass production of the proposed material (knitted fabric (sheet or blanket)) through a low-cost, scalable synthesis approach, which requires no vacuum conditions, or inert atmosphere, all of which significantly reduce market entry and material adoption barriers currently being faced by new materials. Moreover, these techniques open up a cost-effective and sustainable route for synthesis whilst concurrently optimizing a top-down approach.

The fabric (sheet or blanket) in accordance with the present invention has wide spread applications predominantly in the defense, aerospace and/or satellite fields. In an embodiment of the present invention, the MLI fabric comprises coating of freestanding borophene and its hybrids, for enhanced thermal management, EMI/RFI (electro-magnetic interference or radiofrequency interference) shielding, and electrostatic conductivity. In another embodiment, the proposed MLI fabric is used for galvanic shielding, NEMP protection, space charging, and against atomic-oxygen corrosion. Other related advantages of the proposed fabric includes simplified design, ease of manufacture, low maintenance costs, economical and user-friendly. In another embodiment, the proposed fabric may also be employed for radiation shielding in the medical field particularly for X-rays and MRI applications. Also, the fabric may be employed for thermal insulation in extreme environments observed near-polar, and high-altitude regions, to maintain the critical thermal ambience for both equipment and humans.

A systematic comparison of constituent fabric materials (particularly graphene), with other 2D materials, is explained below. Considering dimensional stability (coefficient of thermal expansion), 2D materials surpass the thermal coefficient of all 3D material (bulk) and are, therefore, imperative to study these materials for futuristic scope in Meta-Material Embedded Knitted-Fabric. Among various member of the flatland, freestanding graphene, borophene, boron nitride and their hybrids proposed in the present invention are the best amongst (possessing thermal coefficient 4000 Wm-1K-1 and 1000 Wm-1K-1) all existing materials known by the scientific community. These materials transfer heat in order of few picosecond and thus is considered to be the most suited materials for overcoming thermal heat in Meta-Material Embedded Knitted-Fabric. Secondly, considering surface conductivity, as space surface charging is a menace and can lead to damage of electronic equipment, this challenge is eliminated by using graphene, borophene, and their hybrids having electronic conductivity and highest mobility (amongst all material reported till date). Any material other than freestanding monolayer of graphene and borophene (metallic and semi-metallic) has a bandgap and act as a capacitor for delta period - which is quite enough to damage the electronic circuits or electronic wirings in the spacecraft. Therefore, freestanding monolayer graphene and borophene (metallic and semi-metallic) having zero bandgaps are the best materials to overcome the problem of surface charge.

Next, considering radiation shielding (against EMI, UV and plasma ions), graphene and borophene are some of the 2D materials which have been used for terahertz device application. It can sustain radiations in Terahertz and is therefore among the best 2D materials to overcome EMI Shielding. Finally, considering strength against sheet rupture by meteorites, the rupture of the Meta-Material Embedded Knitted-Fabric is a major concern owing to the varying microgravity from various phases such as launch to operations. Also, satellites or spacecrafts are threatened by meteorites and/or projectiles originating from space-junk, therefore mechanical strength of the material is a great concern. Graphene and borophene possess the maximum Young’s modulus and are of the order of 400 GPa which is nearly 500 times more than the conventional material used for Meta-Material Embedded Knitted-Fabric. The synthesis of 2D materials has never been an easy task, especially when it comes to monolayer layer in bulk quantity. Graphene is the first 2D material which is easy to synthesize at large scale. However, obtaining a monolayer via chemical routes at an industrial scale is still a challenge. Also, freestanding borophene remains an area of concern for manufacturing in large scale due to less yield and high cost and procuring boron crystal or powder is another hurdle considering its use in nuclear reactions. Moreover, large scale synthesis of boron nitride and its hybrids through chemical routes, is a challenge to overcome.

Considering added advantages of using a polyimide outer surface for the proposed fabric (sheet or blanket), polyimide (PI) fibers are a class of polymeric materials with imide rings embedded in macromolecular chains. Its highly conjugated structure has endowed it with outstanding mechanical and dielectric properties, relatively high thermal stability, good chemical resistance, and excellent radiation shielding. These properties impart an edge to polyimides over high-tech polymeric fibers upon being subjected to extreme temperature, vibration and other demanding conditions. It has a wide range of applications in the aerospace sector and the intrinsic properties of polyimide make it an ideal candidate for space applications, such as camera circuits, MLI sheets, etc. Polyimides exhibit superb mechanical toughness, and resistance to puncture, tear, abrasion and wear over a broad temperature range of (-250 to 500)°C, and thus offers better protection against high-velocity micro-meteorites and space junk that can fatally damage the satellite or spacecraft equipment upon impact. Likewise, polyimides exhibit high thermal stability due to the characteristic low thermal expansion coefficient. The spacecraft and/or equipment in orbit is subjected to extreme cyclic thermal loadings at high frequency, as they move in/out of the planetary shadow. Thus, polyimides are ideal candidates to ensure the safety and proper functioning of the equipment under such harsh conditions. Moreover, polyimides are high-performance electrical insulator with high dielectric strength. They provide good resistance to partial electric discharges (corona effect). It keeps the equipment safe from short-circuits caused by space charging, and subsequent differential, and/or internal charging.

Lastly, polyimides exhibit excellent radiation shielding, particularly against- gamma and UV rays. Since, the orbiting spacecraft or equipment are exposed to high radiation flux, polyimides offer a superior coating or covering to achieve shielding for the safety and proper functioning. In space orbit, the effects of vacuum and temperature changes can be coupled with the irradiation of electrons and protons, atomic oxygen erosion, and the influence of photons from UV exposure. Thus, polyimides having a unique combination of electrical, thermal, chemical, mechanical and irradiation properties - offer a high performance, reliable and durable solution for space applications. Considering the details or advantages of using blended reduction protocol involving thermal as well as microwave reduction technique, as part of the proposed synthesis process - blended reduction protocol helps to attain pristine material properties within a short lifespan of reduction technique. Moreover, it will also enable to tune the conductivity and mobility of the material - as required.

Many changes, modifications, variations and other uses and applications of the subject invention will become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims which follow.

1. A multi-layer two-dimensional (2D) knitted insulation material or fabric, comprising:
a sheet or a blanket comprising a plurality of alternating layers of insulating materials, with a metal foil and a spacer between the plurality of alternating layers of insulating materials coated with borophene, boron nitride and graphene hybrid coating, wherein outer layers of the multi-insulation material comprise of polyimide.

2. The multi-layer two-dimensional (2D) knitted insulation material or fabric of claim 1, wherein the spacer comprises freestanding monolayer of borophene or hybrids of borophene/plumbene.

3. The multi-layer two-dimensional (2D) knitted insulation material or fabric of claim 1, wherein the foil includes metal foil comprising silver or aluminium.

4. The multi-layer two-dimensional (2D) knitted insulation material or fabric of claim 1, wherein the metal foil is coated on a single side, or both sides with the borophene, boron nitride and graphene hybrid coating.

5. (canceled)

6. The multi-layer two-dimensional (2D) knitted insulation material or fabric of claim 1, being in the form of a knitted wire-mesh patterned fabric.

7. A method of manufacturing a meta-material embedded fabric, the method comprising the steps of:
- embedding borophene and hybrids of borophene with a two dimensional (2D) material;
- integrating borophene or plumbene hybrid flakes under an inert ambience with the 2D material;
- synthesizing the embedded borophene and hybrids of borophene using a sonochemical technique; and reducing the synthesized freestanding borophene or plumbene and hybrids of borophene using a blended reaction protocol, thereby forming the meta-material embedded fabric.

8. The method of claim 7, wherein the borophene used is freestanding borophene.

9. The method of claim 7, wherein the inert ambience comprises dispersing the hybrid flakes in nitrogen gas, to result in strong thermal resistance against heat conduction.

10. The method of claim 7, wherein the 2D material is coated on to the Kapton or Mylar foils.

11. The method of claim 7, wherein synthesizing the embedded borophene and hybrids of borophene is performed using the sono-chemical technique along with a modified Hummer’s technique.

12. A meta-material embedded fabric, comprising:
a plurality of insulating layers, a polyimide outer surface with a coating of:
freestanding borophene, and
boron nitride; and
a plurality of graphene hybrid layers.

13. The meta-material embedded fabric of claim 12, wherein the meta-material embedded fabric acts as a shield against thermal flux, hostile radiations, space junk, galvanic corrosion, atomic oxygen and is fire resistant.

14. The meta-material embedded fabric of claim 12, wherein a monolayer of freestanding borophene or boron nitride hybrids are introduced as a spacer between the plurality of insulating layers.

15. The meta-material embedded fabric of claim 12, wherein freestanding borophene and boron nitride hybrids flakes are dispersed in nitrogen gas between the plurality of insulating layers, thereby offering strong thermal resistance against heat conduction.
